(19) United States
(12) Patent Application Publication
(10) Pub. No.: US 2026/0035249 A1
(43) Pub. Date: Feb. 5, 2026

(54) Carbon Composite Materials, Methods of Manufacturing Such Carbon Composite Materials, Conduits And Components Made Of Such Composite Materials, And A Molten Salt Nuclear Reactor Comprising Carbon Composite Components

(71) Applicant: Copenhagen Atomics A/S, Kastrup (DK)

(72) Inventors: Thomas Jam PEDERSEN, Copenhagen K (DK); Thomas STEENBERG, Copenhagen K (DK); Aslak STUBSGAARD, Copenhagen K (DK)

(73) Assignee: Copenhagen Atomics A/S, Kastrup (DK)

(21) Appl. No.: 18/680,188

(22) Filed: May 31, 2024

(30) Foreign Application Priority Data
Jul. 5, 2023 (DK) PA202330117

(51) Int. Cl. C01B 32/21; G21C 3/54; G21C 5/12

(52) U.S. Cl. CPC C01B 32/21; G21C 3/54; G21C 5/12; C01P 2004/10

(57) ABSTRACT

A carbon composite channel (10) and method of manufacturing a carbon composite channel. The method entails applying layers of carbon fiber alternatingly in a circumferential and an axial direction, applying liquid carbon, a liquid carbon-containing solution, or a liquid pre-cursor for glassy carbon to one or more layers of carbon fiber before applying the next layer of carbon fiber, and subsequently curing the pre-cursor by exposure to a heat treatment at a temperature below 1200° C.

This application claims priority to Danish Application PA 2023 30117, filed Jul. 5, 2023.

### TECHNICAL FIELD

The disclosure relates to carbon composite materials (especially carbon/carbon composites) for containing high-temperature fluids, in particular molten salt in a molten salt reactor, methods of manufacturing such carbon composite material, conduits, and components made from such carbon composite material, and to methods of manufacturing such conduits and components.

### SUMMARY

It is an object to provide carbon composite material with a matrix comprising glassy carbon. It is another object to provide a method of manufacturing carbon composite material with a matrix comprising glassy carbon. It is yet another object to provide an object with walls formed of carbon composite material having a matrix comprising glassy carbon.

It is another object to provide a method for manufacturing carbon composite material that is substantially leak-tight and has little or no porosity. It is another object to provide a carbon composite material that is substantially leak-tight and has little or no pores. Is an object to provide a carbon composite object with at least one perimeter that is suitable for welding to a metal, preferably steel, object. It is another object to provide a method for manufacturing a carbon composite object with at least one parameter that is suitable for welding to a metal object. If is another object to provide an object manufactured from carbon composite material with at least one perimeter that is suitable for welding to a metal object.

The foregoing and other objects are achieved by the features of the independent claims. Further implementation forms are apparent from the dependent claims, the description, and the figures.

According to a first aspect, there is provided a method of manufacturing a carbon composite channel having a lumen, the method comprising:
providing a core with a shape corresponding to the lumen,
applying layers of carbon fiber alternatingly in a circumferential and an axial direction,
applying a liquid carbon or a liquid pre-cursor for glassy carbon to one or more layers of carbon fiber before applying the next layer of carbon fiber, and
subsequently curing the pre-cursor by exposure to a heat treatment at a temperature below 1200° C.

According to a possible implementation form of the first aspect, the carbon composite channel is a C/C composite carbon channel.

According to a possible implementation form of the first aspect, the method comprises applying the liquid carbon, a carbon-containing liquid solution, or liquid pre-cursor for glassy carbon to one or more layers of carbon fiber before applying the next layer of carbon fiber as a coating.

According to a possible implementation form of the first aspect, the method comprises applying the liquid precursor for glassy carbon as a viscous liquid, the viscous liquid preferably comprising phenolic resin or furfuryl alcohol.

According to a possible implementation form of the first aspect, the method comprises binding the glassy carbon pre-cursor to the carbon fibers and creating an interlayer stuffing, preferably minimizing voids/porosity in the material to 3-0.01%

According to a possible implementation form of the first aspect, the method comprises applying the precursor to the carbon fiber by a winding machine just before the carbon fiber is wound onto the core or previously applied axially extending layer of carbon fibers.

According to a possible implementation form of the first aspect, the method comprises mixing graphite powder, short carbon fibers, or chunks so graphene into the liquid precursor for glassy carbon as a filler to form a paste, preferably adding methyl ethyl ketone to the mixture to render it more workable.

According to a possible implementation form of the first aspect, the method comprises adding glassy carbon powder to the liquid precursor for glassy carbon as a sintering aid.

According to a possible implementation form of the first aspect, the method comprises performing the heat treatment in an oxygen-free or low-oxygen environment, preferably in a vacuum furnace.

According to a possible implementation form of the first aspect, the method comprises applying isostatic pressing after the heat treatment.

According to a possible implementation form of the first aspect, applying carbon fibers in the circumferential direction comprises winding the carbon fibers onto the core or onto an already applied axially directed layer of carbon fibers.

According to a possible implementation form of the first aspect, the circumferential layers of carbon fibers are applied by winding a single carbon fiber onto the core or onto an already applied layer of axially directed carbon fibers, preferably by applying a single-strand of carbon fiber onto the core or already applied layer of axially directed carbon fibers right next to the last wound carbon fiber so there is no or as little as possible space between windings of carbon fiber.

According to a possible implementation form of the first aspect, the method comprises providing a thin sheet of carbon fiber with fibers arranged in a single direction, and applying the thin sheet of carbon fiber to the core or to an already applied circumferentially directed layer of carbon fibers, with the carbon fibers in the thin sheet being axially directed relative to the core.

According to a possible implementation form of the first aspect, the method comprises applying a thin layer of adhesive to the thin sheet of carbon fiber or to an already applied circumferentially directed layer of carbon fibers, with the thin layer of adhesive either facing the core 8 of facing radially outward.

According to a possible implementation form of the first aspect, the method comprises applying pressure to the thin sheet of carbon fiber after applying it to the core or already applied circumferentially directed layer of carbon fibers and before applying the next layer of circumferentially directed carbon fibers.

According to a possible implementation form of the first aspect, the method comprises removing the core, preferably by melting the core in a heat treatment or by dissolving the core with a solvent.

According to a possible implementation form of the firths aspect, the method comprises one or more thin ductile metal barrier layers between the layers of carbon fiber.

According to a second aspect, there is provided a carbon composite channel manufactured according to the method of any one of the preceding implementations.

According to a third aspect, there is provided a method of manufacturing a glassy carbon object, the method comprising:
mixing phenolic resin or furfuryl alcohol with graphite powder, carbon fibers having a length no longer than 10 mm, and/or graphene chunks to form a paste,
preferably adding an amount of methyl ethyl ketone to the mixture to make the mixture more workable,
adding an amount of glassy carbon powder to the mixture to act as a sintering aid,
subsequently, shaping the mixture into a desired shape and let it cure at room temperature in vacuum,
subsequently, pre-baking the mixture at a relatively low temperature of approximately 100-200° C. for several hours, also in vacuum,
subsequently, machining the resulting blank into the desired shape,
subsequently subjecting the shaped blank to isostatic pressing, preferably at a temperature of 2000-2500° C. in an inert atmosphere such as argon or nitrogen.

According to a possible implementation form of the third aspect, the method comprises removing the blank from the furnace and allowing it to cool slowly to room temperature.

According to a possible implementation form of the third aspect, the method comprises machining or polishing the blank as needed.

According to a fourth aspect, there is provided a glassy carbon object manufactured according to the method according to the third aspect.

According to a fifth aspect is provided a method of manufacturing a carbon composite channel having a lumen and a first axial extent L1, the method comprising:
providing a core with a shape corresponding to the lumen,
applying a number of layers of axially or circumferentially directed carbon fibers onto the core,
subsequently alternatingly applying:
   a number of long layers of carbon fiber alternatingly onto one another in a circumferential and an axial direction over a second axial extent L2 that is shorter than the first axial extent L1 and with the axial extremities of the layers of carbon fibers aligned, and
   a number of short layers of carbon fiber alternatingly onto one another in a circumferential and an axial direction over a third axial extent L3 that is shorter than the second axial extent with one of the axial extremities of the short layers of carbon fiber aligned with one of the axial extremities of the long layers of carbon fiber thereby leaving a portion of previously applied long layers of carbon fiber exposed and placing a thin metal sheet on the exposed portion of the previously applied long layer of carbon fiber with the thin metal sheet axially projecting from the previously applied long layer of carbon fiber.

According to a possible implementation form of the fifth aspect, the carbon composite channel is a C/C carbon composite channel.

According to a possible implementation form of the fifth aspect, the method comprises providing the thin metal sheet with one or more holes in the portion in which the thin metal sheet overlaps with the long layer of carbon fiber.

According to a possible implementation form of the fifth aspect, the method comprises bonding the carbon fiber sheet layers on opposite sides of a hole in the thin metal sheet to one another in the area of the hole.

According to a possible implementation form of the fifth aspect, the method comprises applying the layer of thin sheet metal in the form of pipe sections.

According to a possible implementation form of the fifth aspect, the method comprises applying the layer of thin sheet metal by circumferentially winding thin sheet metal onto the exposed portion of a previously applied long layer of carbon fiber.

According to a possible implementation form of the fifth aspect, circumferentially winding the thin sheet metal comprises spirally winding the thin sheet metal onto succeeding long layers of carbon fiber.

According to a possible implementation form of the fifth aspect, the thin sheet metal has a thickness between 0.02 and 0.1 mm, preferably approximately 0.05 mm.

According to a possible implementation form of the fifth aspect, the method comprises applying the axially directed short and/or long layer of carbon fibers as a sheet of axially directed short and/or long carbon fibers.

According to a possible implementation form of the fifth aspect, the method comprises curing carbon composite channel in the vacuum oven.

According to a possible implementation form of the fifth aspect, the method comprises pressing the exposed portion of the layers of thin sheet metal together under high force, preferably using a purpose-built tool,

According to a possible implementation form of the fifth aspect, the method comprises welding the exposed portion of the thin sheet metal.

According to a possible implementation form of the fifth aspect, the method comprises applying one or more rotations of welding with filler.

According to a possible implementation form of the fifth aspect, the method comprises milling the solid metal brim to obtain a machined solid metal end, preferably on a lathe or milling machine.

According to a possible implementation form of the fifth aspect, the method comprises of one or more thin ductile metal barrier layers between layers of carbon fiber.

According to a sixth aspect, there is provided a carbon composite channel manufactured according to the method of the fifth aspect and any possible implementations thereof.

According to a seventh aspect, there is provided a molten salt nuclear reactor comprising one or more molten salt loops, at least one of the molten salt loops comprising a reactor core, wherein at least one of the molten salt loops and/or the nuclear reactor core comprises a carbon composite channel according to the second aspect.

These and other aspects will be apparent from the examples and embodiments described below.

### BRIEF DESCRIPTION OF THE DRAWINGS

In the following detailed portion of the present disclosure, the aspects, embodiments, and implementations will be explained in more detail with reference to the example embodiments shown in the drawings, in which:

FIG. 1 is a diagrammatic side view of a core for use in an embodiment of a method of manufacturing a carbon composite channel 10.

FIG. 2 is a diagrammatic side view of the core of FIG. 1 with a first embodiment of a carbon composite channel manufactured thereon.

FIG. 3 is a diagrammatic side view of the core of FIG. 1 with a second embodiment of a carbon composite channel manufactured thereon.

FIG. 4 is a diagrammatic side view of the carbon composite channel of FIG. 3.

FIG. 5 is an elevated cutaway view of one axial end of the carbon composite channel of FIG. 2.

FIG. 6 is an elevated cutaway view of one axial end of the carbon composite channel of FIG. 3.

FIG. 7 is an elevated view of one axial end of the carbon composite channel of FIG. 3.

FIG. 8 is a view of an axial end of a carbon composite channel according to a third embodiment.

FIG. 9 is an elevated cutaway view of one axial end of the carbon composite channel of FIG. 8.

FIG. 10 is another elevated cutaway view of one axial end of the carbon composite channel of FIG. 8.

FIG. 11 is a diagrammatic representation of a molten salt nuclear reactor.

### DETAILED DESCRIPTION

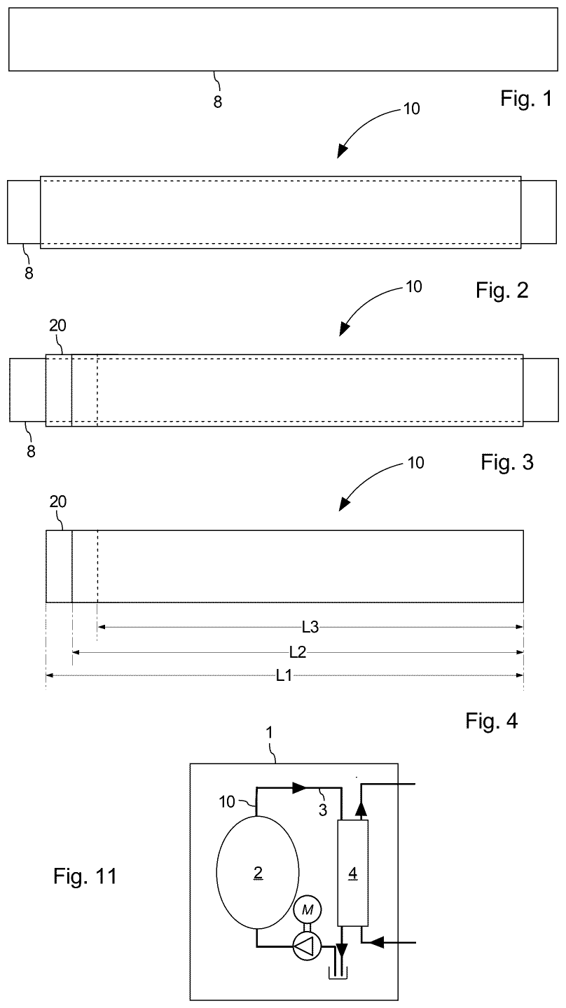

FIGS. 1, 2 and 5 relate to the first embodiment of a method of manufacturing comments composite channel 8 and to the first embodiment of a carbon composite channel 8, preferably a C/C carbon composite channel. The carbon composite channel 8 is shown as a circular member with a lumen, but it should be understood that the channel 8 could be a container with closed ends by adding end caps or the like and that the channel does not have to be circular, but could have any other cross-sectional shape. Further, the channel 80 shown is a straight channel, i.e. extending straight along its axial extent, but it should be understood that the axial extent could be curved or angled. the channel 10 can be used as a pipe or conduit, or as a container for gas and/or liquid. The channel 10 can for example be a conduit or container for use in a molten salt nuclear reactor, to contain or transport molten salt, off gas and/or cover gas.

The starting point for the carbon composite channel 10 is to provide a solid or porous shape that acts as a positive mold (core 8). This mold is covered with carbon fiber and matrix material, which forms a mechanically self-supporting geometry with the desired shape. Several layers of carbon fiber cloth and matrix material may be applied in order to obtain the desired thickness and strength. The mold material can be removed either by melting or thermal decomposition, thus resulting in the desired shape. Heat treatment in an inert or reducing atmosphere converts the shape into a porous carbon structure comprising phenolic resin or furfuryl alcohol

The porosity in the porous carbon structure can be removed or at least reduced by impregnating with the starting material and subsequent heating. The initial form and dimensions of the porous structure can be maintained by optimizing the ratio between the porous structure and the amount of impregnating material. The process can be repeated until the desired properties have been achieved, or this densification method can be combined with other examples of densification processes.

Other examples of densification processes are:
Impregnation with a matrix material, e.g. liquid carbon containing solution, and subsequently, carbonization/graphitization by heat treatment in an inert or reducing atmosphere,
In-situ decomposition of a hydrocarbon gas inside the porous structure with or without subsequent heating in an inert or reducing atmosphere,
Plating the structure with a metal either through electrochemical reduction from a solution or through flame/plasma spraying

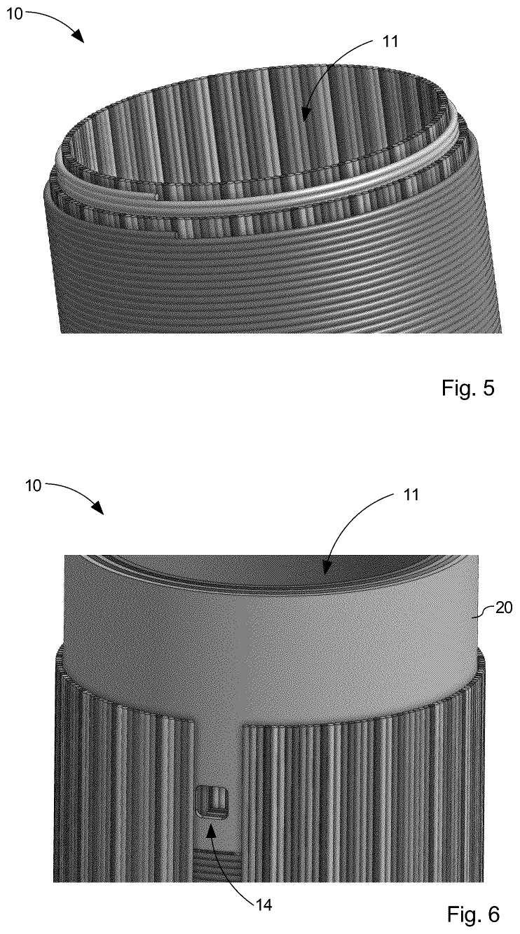

FIG. 5 is an elevated partially cut-away view of a channel 10 according to a first embodiment. Channel 10 is manufactured by applying layers of carbon fiber alternating between the circumferential direction and the axial direction. The manufacturing method starts with an inner core 8 made out of a material that melts at 95-100° C. and which is easy to clean off the inner wall of the resulting carbon composite channel 10. In the following, we will assume that microcrystalline wax is used, but metals with a low melting point can potentially also be used. alternatively, the substance that can be dissolved in a solvent could be used for the core 8. To clean the inner surface of the carbon composite channel from unwanted materials, a laser cleaner can be used.

A layer of carbon fiber is applied to the inner core. When a layer of carbon fiber (each fiber typically having a thickness varying between (0.005-0.1 mm) is applied in the circumferential direction it is wound onto the core or existing layer of carbon fiber with a winding machine which ensures that each carbon fiber is placed right next the previous winding in a single layer of carbon fibers, i.e. without space between the consecutive windings. After a single layer or a few layers have been applied in the circumferential direction a thin sheet of carbon fiber with the carbon fibers in the axial direction is applied. This thin sheet has an ultra-thin layer of adhesive on one side, which helps to stick to the previously applied layer of carbon fibers. Next, a new layer of carbon fiber is applied in the circumferential direction by the winding machine as described above. If bumps occur on the surface, which are higher than two layers of carbon fiber (0.02 mm) then this bump is ground down to ensure that the surface stays even during the manufacturing process. After each thin sheet is applied pressure is applied to the outer surface to make sure each layer is packed as tightly together as possible, preferably with a dedicated tool for applying pressure. This pressure application to can be removed one section at a time as the winding machine progresses.

If the carbon composite channel 10 has an odd shape, then the thin sheets of carbon-fiber which are applied in the axial direction can consist of several pre-cut sheets which match the odd shape well.

The thin sheet of carbon fiber is manufactured using a similar process as described below. Carbon fiber is wound onto a reel, for example, 100 cm in diameter and 60 cm in width. This reel is preferably made of carbon but has a thin layer of surface coating that will not stick to the carbon fibers during the curing process. The winding machine winds a single strand of carbon fiber onto the reel and ensures that the consecutive windings are placed right next to each other. When one or a few layers have been applied the reel is placed in the oven to cure the thin sheet. The carbon fibers will bind together with their neighbors forming a thin sheet of carbon fiber, which can be cut off the reel after the curing process by cutting in the axial direction. Because the thin sheet is very thin, it can be and is unrolled from the reel and flattened into a flat sheet, to obtain a thin sheet of carbon fibers. In the case of the reel size described above the size of the resulting thin sheet is 314×60 cm and 0.02 mm thick.

Next an ultra-thin layer of adhesive is applied on one side of the thin sheet of carbon fibers and if needed a plastic liner is applied to protect the adhesive side in the next steps. Then the thin sheet is cut into shape using for example a laser cutter.

Because the original carbon fibers are not uniform in their thickness (0.005-0.01 mm) there will be small gaps between neighboring carbon fibers when they are wound onto the pipe or reel with the winding machine. Therefore, the layers will not be 100% leak-tight. To solve this problem an oil-like substance which is a precursor for the production of glassy carbon components is applied to the carbon fiber by the winding machine just before the carbon fiber is wound onto the pipe or reel. The oil-like substance can for example be phenolic resin or furfuryl alcohol. In the curing process, this glassy carbon pre-cursor will bind to the carbon fibers and create an inter layer stuffing, preferably minimizing voids/porosity in the material to 3-0.01%. The pre-cursor is cured by exposure to a heat treatment at a temperature below 1200° C. The heat treatment is performed in an oxygen-free or low-oxygen environment, preferably in a vacuum furnace. After applying several hundred layers of thin sheets, the resulting channel is leak-tight for molten salts, such as fluoride or chloride salt.

FIGS. 1, 3, 6 and 7 relate to the second embodiment of a method of manufacturing comments composite channel 8 and to the second embodiment of a carbon composite channel 8. In this embodiment, structures, and features that are the same or similar to corresponding structures and features previously described or shown herein are denoted by the same reference numeral as previously used for simplicity. In this embodiment, the method of manufacturing is partially the same as in the first embodiment. In particular, the way in which the circumferentially and axially directed carbon fiber layers are applied is essentially the same as for the first embodiment.

FIG. 6 is an elevated partially cut open view of an object with the wall of a carbon composite material that has a periphery of metal, preferably steel, that allows it to be welded to another metal object, preferably steel.

In this embodiment of the carbon composite channel 10 the layers of a carbon composite channel are interlaced with layers of thin sheet metal 20, preferably steel, and the carbon composite channel 10 fiber is manufactured by alternating between the circumferential direction or the axial direction, while applying these alternating layers of carbon fiber a layer of thin sheet metal 20, e.g. 0.05 mm thickness (can be anywhere between 0.01 and 0.1 mm thickness) and with holes 14 in the sheet metal where it overlaps with the carbon fibers is inserted every number of layers of carbon fiber, the number could be anywhere from 1 to 10. The sheets of metal 20 are inserted so that they partially are embedded between layers of carbon fiber and partially protrude from the object made of carbon composite material, to form a perimeter, in this example the longitudinal end of the carbon composite channel 10 that is completely formed of metal sheets. Thus, the longitudinal end portion of the object is metal that can be welded. Preferably, the longitudinal extent of this portion has a width (in the axial direction of the carbon composite channel 10) of several millimeters to allow the plurality of metal sheets to be formed into a solid metal pipe 10 as described below.

Either the carbon fibers in the circumferential direction or the carbon fibers in the axial are not applied in the volume taken up by the overlapping sheet metal. The overlap can preferably be approximately 50 mm, but the overlap can be longer or shorter depending on the application and the pressure requirements. The thin sheet metal sections 20 can be made of pipe sections.

Thus, the method of manufacturing a carbon composite channel 10 with a first axial extent L1, according to the second embodiment comprises providing core 8 with a shape corresponding to the lumen (11) an axial extent larger than the first axial extent L1. Applying a number of layers of axially or circumferentially directed carbon fibers onto the core 8, subsequently alternatingly applying:
a number of long layers of carbon fiber alternatingly onto one another in a circumferential and an axial direction over a second axial extent L2 that is shorter than the first axial extent L1 and with the axial extremities of the layers of carbon fibers aligned,
and
a number of short layers of carbon fiber alternatingly onto one another in a circumferential and an axial direction over a third axial extent L3 that is shorter than the second axial extent with one of the axial extremities of the short layers of carbon fiber aligned with one of the axial extremities of the long layers of carbon fiber thereby leaving a portion of previously applied long layers of carbon fiber exposed and placing a thin metal sheet 20 on the exposed portion of the previously applied long layer of carbon fiber with the thin metal sheet 20 axially projecting from the previously applied long layer of carbon fiber.

In one example of an implementation forty layers of thin sheet metal interlacing each 0.05 mm thick are used, resulting in a total metal pipe thickness of 2 mm. When the thin sheet metal pipe sections are manufactured on a machine they need to have very tight tolerances, such that they barely fit inside each other. Thus, forty different diameters of pipe will be required. The assembly process needs to take into account the tolerances in the diameter of each of the forty layers of thin sheet metal pipe and slide them onto the end of the alternating circumferential or axial direction wound carbon composite channel 10, such that a heated sheet metal part slides over the end of the carbon composite channel 10 and when cooled fits tight around the carbon composite channel 10. In an embodiment, the thin sheet metal pipe sections have holes in there where they overlap with the carbon composite channel 10. These holes will allow fibers from the layer below the thin metal sheet, tend to bind with the carbon fibers from the layer above the thin metal sheet through the holes and thus create a very strong bonding between the metal sheet and the adjourning carbon fiber layers.

FIG. 6 shows how several layers of stainless steel pipe sections are mounted at the end of a pipe. The square holes 14 with rounded corners in the stainless steel pipe sections make it possible for carbon fibers from one layer to bind to the next layer and thereby holding the stainless steel pipe sections in place. The diameter of the carbon fibers is exaggerated for visualization purposes. in reality, there would be more than 1000 carbon fibers across the size of the square hole. Also, in reality, the square holes would not align, thus you would not be able to see through.

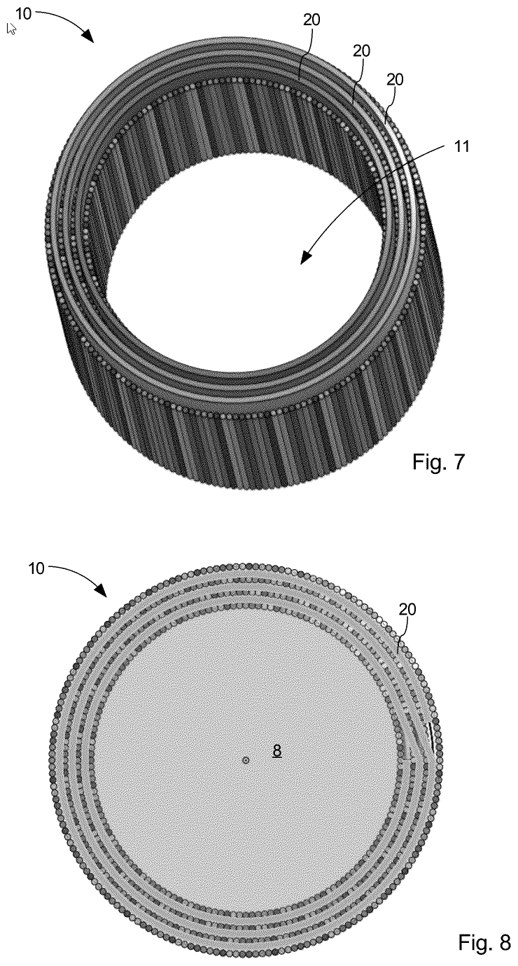

FIG. 7 shows three rings of thin sheet stainless steel 20 at one end of the carbon composite channel 10. The thickness of the carbon fibers and thin sheets 20 are abnormally large for visualization purposes, in reality, there will be many thousands of carbon fibers and hundreds of stainless steel sheets. When the channel 10 has been heated (cured) and the carbon fibers have bonded together, then the thin sheets 20 of stainless steel are pressed together with a purpose-built tool and then welded to merge all the sheets together.

Thus, after the carbon composite channel 10 has been cured in a vacuum oven, the hundreds of thin layers of thin sheet metal in the ends are pressed together under high force using a purpose-built tool and then the layers are welded together from the end. Typically, several rotations of welding are applied with filler, making a 1-5 mm brim at the end of the carbon composite channel 10 which is a solid metal pipe. After the welding process, the ends are milled on the lathe or other machine to obtain a solid end, which looks just like any regular metal pipe e.g. with a 2 mm wall thickness. It is then possible to weld other pipes or flanges onto this end as if the pipe was a regular metal pipe.

FIGS. 1, 3, 8, 9 and 10 relate to the second embodiment of a method of manufacturing comments composite channel 8 and to the second embodiment of a carbon composite channel 8. In this embodiment, structures, and features that are the same or similar to corresponding structures and features previously described or shown herein are denoted by the same reference numeral as previously used for simplicity. In this embodiment, the method of manufacturing is partially the same as for the second embodiment, except that the thin sheet metal is applied differently.

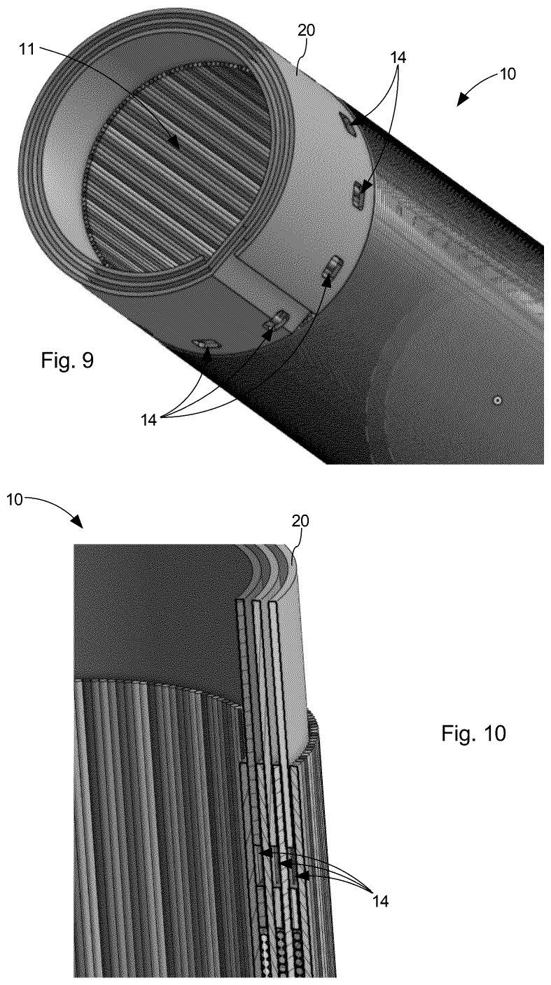

FIG. 8 is an end view and FIGS. 9 and 10 are elevated views of a carbon composite channel 10 in which the thin metal sheet 20 at the end of the pipe is circumferentially and spirally wound onto the layers of carbon fibers as the carbon fiber layers are added. The thickness of the fibers and the middle sheet are abnormally large for visualization purposes.

FIG. 9 is an elevated view of the carbon composite channel 10, the end spiral representing the stainless steel sheet 10 which is rolled onto the end of the carbon composite channel 10 as the layers of the carbon composite channel 10 are being added. The thickness of the stainless steel sheet carbon fibers are abnormally large for visualization purposes.

FIG. 10 is an elevated sectional view of the carbon composite channel 10 of FIG. 9 showing how carbon fibers are wound alternating between the circumferential and longitudinal direction of the pipe 10. Three thin layers of stainless steel sheet 20 are inserted between the layers of carbon fiber and attach better by having holes 14 through which the carbon fibers are bonded from one layer to the next. The thickness of the stainless steel sheet carbon fibers is drawn abnormally large in the Figures for visualization purposes. Because of the abnormally large thickness of the carbon fibers in these Figures the Figures are somewhat misleading, in reality, the width of each hole 14 spans across thousands of carbon fibers.

Thin layers of stainless steel sheet metal are applied to longitudinal the end of the carbon composite channel 10 by winding a thin metal sheet 20 in between the layers of carbon fiber. The circumferentially wound carbon fibers will stop where the thin stainless steel sheet metal windings start. Thus, only the layers of carbon fibers in the axial direction overlap with the stainless steel sheet at the ends. The typical thickness of this metal sheet is 0.01-0.02 mm. For every 2nd-20th layer of thin sheet carbon fiber an additional layer of the stainless steel interface onto the pipe and allow it to overlap for example 50 mm and stick out another 50 mm. The stainless steel interface has holes or other shapes cut into it on the part which overlaps with the carbon composite part of the pipe. Because the carbon fibers will bind together in the curing process, the carbon fibers from the layers on either side of the stainless steel interface will bind through the holes 14 and this will make the binding between the stainless steel interface and the alternating carbon composite layers very strong. Tests have shown that these pipes with their stainless steel interface can handle pressures above 50 bar.

After the carbon composite pipe has been cured in a vacuum oven, several hundreds of thin layers of stainless steel interface in the ends are pressed together under high force and then the layers are welded together from the stainless steel end. Typically, several rotations of welding are applied with filler, making a 1-5 mm brim at the end of each pipe which is solid stainless steel. After the welding process, the ends are milled on the lathe or other machines to obtain a solid end, which looks just like any other stainless steel pipe or channel end. It is then possible to weld other pipes or flanges onto this end as if the pipe was any other stainless steel pipe.

After removing the wax core, the carbon composite channel 10 is cured in a vacuum oven at high temperatures to make the carbon fibers bind together and form a solid pipe.

FIG. 11 is a diagrammatic representation of a molten salt nuclear reactor 1 comprising a molten salt loop 2 passing through a nuclear reactor core 3 and a heat exchanger 4. The molten salt loop 2 comprises carbon composite channel 10.

A method will be described to manufacture an object with walls of a carbon composite material with a matrix containing glassy carbon.

### Materials Needed

Phenolic resin or furfuryl alcohol (as a precursor material)
Graphite powder (as a filler)
Methyl ethyl ketone (as a solvent)
Glassy carbon powder (as a sintering aid)
Isostatic press
Vacuum furnace
Lathe or milling machine.

### Process

1. Mix the phenolic resin or furfuryl alcohol with the graphite powder to form a paste. The exact ratio of resin to graphite depends on the desired properties of the final object but typically ranges from 50:50 to 70:30 (by weight). Instead of graphite powder, one can also use 1-10 mm long carbon fibers or small chunks of graphene to obtain fiber reinforced glassy carbon (CF-GC).
2. Add a small amount of methyl ethyl ketone to the mixture to make it more workable.
3. Add a small amount of glassy carbon powder to the mixture to act as a sintering aid. This helps to increase the density and strength of the final crucible.
4. Shape the resulting paste into the desired object shape and let it cure overnight at room temperature in a vacuum bag.
5. Pre-baking: After the curing step, the resulting blank should be pre-baked at a relatively low temperature of around 100-200° C. for several hours. This helps to remove any residual solvents and further harden the crucible also in the vacuum bag.
6. Using a lathe or milling machine to shape the blank. It is important to ensure that the walls of the crucible are thick enough to withstand the high temperatures and pressure that it will be subjected to during the sintering process.
7. Place the shaped blank in an isostatic press and apply pressure to compress the paste and remove any remaining air pockets. The pressure should be maintained for several hours to ensure that the crucible is fully consolidated. A liquid such as oil or water is used as the pressure transmitting medium in the isostatic press. Pressures up to 100 bar can be used.
8. Place the blank in a vacuum furnace and heat it to a temperature of 2000-2500° C. in an inert atmosphere such as argon or nitrogen. The heating rate is typically 1-10° C./minute, depending on the oven and the crucible, and dwell time will depend on the size and shape of the crucible, but typically takes several hours or days. Note that it will shrink by approximately 49% in this process.
9. After the sintering process is complete, remove the blank from the furnace and allow it to cool slowly to room temperature. This helps to prevent cracking or other defects due to thermal shock.
10. Once the blank has cooled, it can be further machined or polished as needed to achieve the desired final dimensions and surface finish.

The resulting product can be used in e.g. a molten salt nuclear reactor, as a component that is particularly temperature and corrosion resistant, for example, a component in the reactor core.

The porosity and/or surface properties of the carbon structures, including those described in the examples, can be modified-surface coatings or densification by liquid or gaseous processes. Sources: Chemistry and Physics of Carbon, vol.9, P.190: Originally A. R. Ford, Engineer, 224, 444 (1967) for carbon composites to be used in molten salt reactors the composite needs to be leak tight for both the salt but also from fission product gasses created in the salt, since they would otherwise diffuse and penetrate the cc composite and result in a large neutron capture, this problem is described in several ORNL reports from the '60s.

The various aspects and implementations have been described in conjunction with various embodiments herein. However, other variations to the disclosed embodiments can be understood and effected by those skilled in the art in practicing the claimed subject-matter, from a study of the drawings, the disclosure, and the appended claims. In the claims, the word “comprising” does not exclude other elements or steps, and the indefinite article “a” or “an” does not exclude a plurality. The reference signs used in the claims shall not be construed as limiting the scope. Unless otherwise indicated, the drawings are intended to be read (e.g., cross-hatching, arrangement of parts, proportion, degree, etc.) together with the specification, and are to be considered a portion of the entire written description of this disclosure.

We claim:

1. A method of manufacturing a carbon composite channel (10) having a lumen (11), the method comprising:
providing a core (8) with a shape corresponding to the lumen (11),
applying layers of carbon fiber alternatingly in a circumferential and an axial direction,
applying a liquid pre-cursor for glassy carbon to one or more layers of carbon fiber before applying the next layer of carbon fiber, and
subsequently curing the liquid pre-cursor by exposure to a heat treatment at a temperature below 1200° C.

2. The method according to claim 1, comprising applying the liquid precursor for glassy carbon as a viscous liquid, the viscous liquid preferably comprising phenolic resin or furfuryl alcohol.

3. The method according to claim 1, comprising binding the glassy carbon pre-cursor to the carbon fibers and creating an interlayer stuffing.

4. The method according to claim 3, comprising applying the glassy carbon precursor to the carbon fiber by a winding machine just before the carbon fiber is wound onto the core (8) or previously applied axially extending layer of carbon fibers.

5. The method according to claim 2, comprising mixing graphite powder, short carbon fibers or chunks of graphene into the liquid precursor for glassy carbon as a filler to form a paste.

6. The method according to claim 2, comprising adding glassy carbon powder to the liquid precursor for glassy carbon as a sintering aid.

7. The method according to claim 1, comprising performing the heat treatment in an oxygen-free or low-oxygen environment.

8. The method according to claim 1, comprising applying isostatic pressing after the heat treatment.

9. The method according to claim 1, wherein applying carbon fibers in the circumferential direction comprises winding the carbon fibers onto the core (8) or onto an already applied axially directed layer of carbon fibers.

10. The method according to claim 1, comprising providing a thin sheet of carbon fiber with fibers arranged in a single direction, and applying the thin sheet of carbon fiber to the core (8) or to an already applied circumferentially directed layer of carbon fibers, with the carbon fibers in the thin sheet being axially directed relative to the core.

11. The method according to claim 1, comprising applying a thin layer of adhesive to the thin sheet of carbon fiber or to an already applied circumferentially directed layer of carbon fibers, with the thin layer of adhesive either facing the core (8) of facing radially outward.

12. A method of manufacturing a glassy carbon object, the method comprising:
mixing phenolic resin or furfuryl alcohol with graphite powder, carbon fibers having a length no longer than 10 mm and/or graphene chunks to form a paste,
adding an amount of methyl ethyl ketone to the mixture to make it more workable,
adding an amount of glassy carbon powder to the mixture to act as a sintering aid,
subsequently, shaping the paste into a desired shape and let it cure at room temperature in vacuum to obtain a blank,
subsequently, pre-baking the blank at a relatively low temperature of approximately 100-200° C. for several hours, also in vacuum,
subsequently, machining the blank into the desired shape, and
subsequently subjecting the shaped blank to isostatic pressing, preferably at a temperature of 2000-2500° C. in an inert atmosphere such as argon or nitrogen.

13. The method according to claim 12, comprising removing the crucible from the furnace and allowing it to cool slowly to room temperature.

14. A method of manufacturing a carbon composite channel (10) having a lumen (11) and a first axial extent L1, the method comprising:
providing a core (8) with a shape corresponding to the lumen (11),
applying a number of layers of axially or circumferentially directed carbon fibers onto the core (8),
subsequently alternatingly applying:
a number of long layers of carbon fiber alternatingly onto one another in a circumferential and an axial direction over a second axial extent L2 that is shorter than the first axial extent L1 and with the axial extremities of the layers of carbon fibers aligned, and
a number of short layers of carbon fiber alternatingly onto one another in a circumferential and an axial direction over a third axial extent L3 that is shorter than the second axial extent with one of the axial extremities of the short layers of carbon fiber aligned with one of the axial extremities of the long layers of carbon fiber thereby leaving a portion of previously applied long layers of carbon fiber exposed and placing a thin metal sheet (20) on the exposed portion of the previously applied long layer of carbon fiber with the thin metal sheet (20) axially projecting from the previously applied long layer of carbon fiber.

15. The method of claim 14, comprising providing the thin metal sheet (20) with one or more holes (14) in the portion in which the thin metal sheet (20) overlaps with the long layer of carbon fiber.

16. The method of claim 15, comprising bonding the carbon fiber sheet layers on opposite sides of a hole (14) in the thin metal sheet (20) to one another in the area of the hole (14).

17. The method of claim 15, comprising applying the layer of thin metal sheet (20) in the form of pipe sections.

18. The method of claim 15, comprising applying the layer of thin sheet metal (20) by circumferentially winding thin sheet metal (20) onto the exposed portion of a previously applied long layer of carbon fiber.

19. The method of claim 18, comprising circumferentially winding the thin sheet metal (20) comprises spirally winding the thin sheet metal (20) onto succeeding long layers of carbon fiber.

20. The method of claim 14, comprising welding the exposed portion of the thin sheet metal (20).

21. The method of claim 20, comprising milling the solid metal brim to obtain a machined solid metal end, preferably on a lathe or milling machine.

22. A method of manufacturing a carbon composite channel (10) having a lumen (11), the method comprising:
providing a core (8) with a shape corresponding to the lumen (11),
applying layers of carbon fiber alternatingly in a circumferential and an axial direction,
applying a liquid carbon to one or more layers of carbon fiber before applying the next layer of carbon fiber, and
subsequently curing the liquid carbon by exposure to a heat treatment at a temperature below 1200° C.

23. The method according to claim 22, comprising binding the liquid carbon to the carbon fibers and creating an interlayer stuffing.

24. The method according to claim 22, comprising applying the liquid carbon to the carbon fiber by a winding machine just before the carbon fiber is wound onto the core (8) or previously applied axially extending layer of carbon fibers.

25. The method according to claim 22, comprising performing a heat treatment in an oxygen-free or low-oxygen environment.

26. The method according to claim 22, comprising applying isostatic pressing after the heat treatment.

27. The method according to claim 22, wherein applying carbon fibers in the circumferential direction comprises winding the carbon fibers onto the core (8) or onto an already applied axially directed layer of carbon fibers.

28. The method according to claim 22, comprising providing a thin sheet of carbon fiber with fibers arranged in a single direction, and applying the thin sheet of carbon fiber to the core (8) or to an already applied circumferentially directed layer of carbon fibers, with the carbon fibers in the thin sheet being axially directed relative to the core.
